(19) United States
(12) Patent Application Publication
(10) Pub. No.: US 2011/0154561 A1
(43) Pub. Date: Jun. 30, 2011

(54) Motorcycle rider safety harness

(76) Inventor: Tara Chand Singhal, Torrance, CA (US)

(21) Appl. No.: 12/655,392

(22) Filed: Dec. 30, 2009

(51) Int. Cl. A41D 13/00; G05D 7/06

(52) U.S. Cl. 2/455; 700/282

(57) ABSTRACT

A motor motorcycle rider safety harness that is suitable to be worn by a motorcycle rider. The safety harness is shaped to position and has positioned on it multiple air-bags that correspond to specific locations of a human body joints that would bear the impact of a falling motorcycle rider in an accidental separation of the rider from the motorcycle. The airbag inflation means may be on the harness on the rider body or it may be on the motorcycle. The inflation control module has (i) sensor means to sense the onset of an accident; (ii) logic means to compute the time for activation of the airbag inflation, and (ii) compressed air storage means, for inflating the air-bags on the onset of the accident. The control module may be on the body of the rider near the stomach area or on the motorcycle itself.

### CROSS REFERENCE TO RELATED APPLICATIONS

None

### FIELD OF THE INVENTION

A motor motorcycle rider safety harness has multiple airbags positioned on it that correspond to specific human body joints that would bear the impact of a falling motorcycle rider in an accidental separation of the rider from the motorcycle.

### BACKGROUND

Motorcycle riders are prone to accidents for various reasons. When a motorcycle accident occurs, the rider's body is thrown off the motorcycle and hits the ground causing severe injuries and possible death or lifetime impairment.

Depending upon the speed of the motorcycle, at the time of the accident, the rider's body separates from the motorcycle and is thrown away from the motorcycle, at the same great speed due to the momentum of the body. When the body impacts the ground, in such an impact, the body is not protected from injury except by wearing of a helmet. Protective clothing such as a padded jacket, pants, gloves and boots also may be used. Jackets and pants with protective pads around shoulders, elbows and other areas provide some protective function.

Helmets are a well recognized and universally used safety means to protect the head from impact injury that protect the driver from severe injury to the head and a high probability of resulting death. While helmets protect the head from injury, the helmets are inadequate to protect the rest of the body from injuries from the accident which are quite severe. The laws of many nations have made wearing helmets for motorcycle rider, a legal requirement. There is no legal requirement for wearing other protective clothing.

The cost of motorcycle accidents is born by the rider, rider's family, friends, and the society at large. Therefore new approaches are needed to protect the motorcycle rider from injuries to the rest of the body besides the head injuries. Hence it is an objective of the preferred embodiments herein to provide a new apparatus and approach of rider safety that would protect the rider body from severe and sometimes serious and debilitating injury to the major joints and to the spine of the body of the rider.

### SUMMARY

A motorcycle rider safety harness worn by a motorcycle rider while riding a motorcycle is described. The light weight safety harness is worn on the outer clothing and is easily worn and removable using tie means that tie the harness around the parts of a motorcycle rider's body using these tie means.

The safety harness is shaped to position and has positioned on it multiple airbags that correspond to specific human body joints that would bear the impact of a falling motorcycle rider in an accidental separation of the rider from the motorcycle. The specific human body joints include at least, the lower spine and the hip joint, shoulders, elbows, and knees. Each airbag is both sized and shaped to the body joint being protected and positioned on the harness to protect the body joint from injury upon impact of the motorcycle rider with the ground.

The multiple airbags of the safety harness are inflated by an inflatable means. The inflation means may be affixed to the motor motorcycle. In an alternative embodiment, the inflatable means are entirely on the harness and there is nothing on the motorcycle, making the harness self-sufficient.

The inflation means of the safety harness has an inflation control-module, which includes (i) sensor means to sense the onset of accidental rider separation from the motorcycle, (ii) logic means to compute the time for activation of the airbags inflation, and (ii) compressed air storage means, for inflating the airbags at the onset of the accident.

These and other aspects of the embodiments are described herein with the help of the accompanying description and the drawings.

### DRAWINGS

The novel features of the embodiments, as well as the embodiments themselves, both as to their structure and their operation, will be best understood from the accompanying drawings, taken in conjunction with the accompanying description, in which similar reference characters refer to similar parts. The drawings are:

FIG. 1: Front and rear view of motorcycle and rider showing features of the safety harness including placement of the airbags on the rider's body.

FIG. 2: Side view of motorcycle showing placement of the inflation control module on the motorcycle according to one embodiment.

FIG. 3: A perspective view of the safety harness, showing multiple airbags and inflation means as part of the harness itself.

FIG. 4: An electronic inflation control module where the module is part of the safety harness.

FIG. 5: Illustrations of versions of safety harness Inflation control logic.

### DESCRIPTION

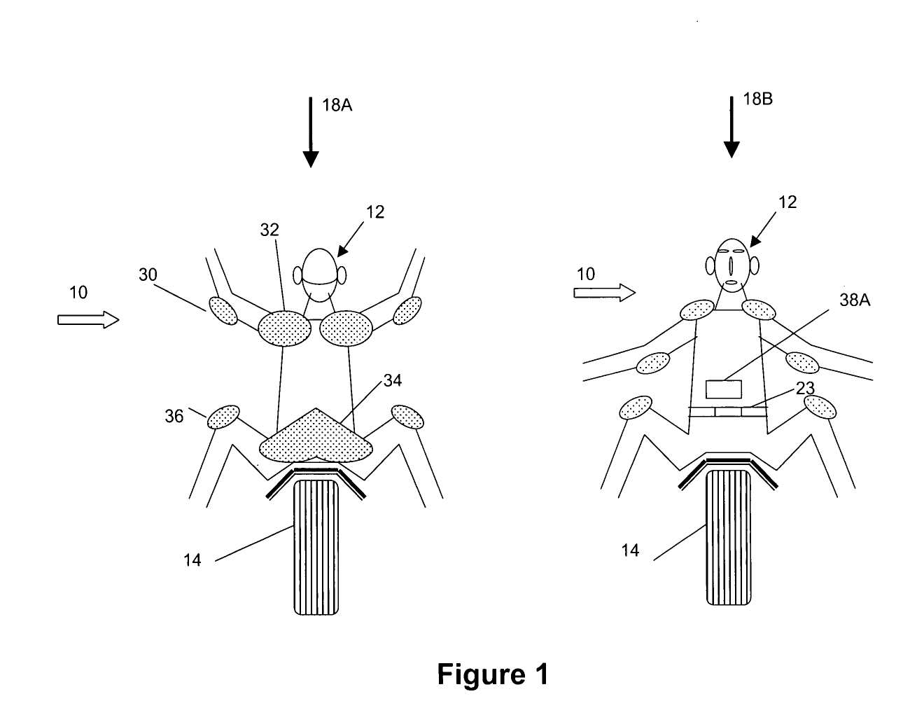

A motorcycle rider safety harness is described with reference to FIGS. 1 to 5. As shown in FIG. 1, a front view 18A and a back view 18B of motorcycle rider body 12 wearing a safety harness 10 on the motorcycle 14 are illustrated.

The motorcycle rider 12 has a safety harness 10 that is worn by the motorcycle rider 12 while riding a motorcycle 14. In one embodiment, the safety harness 10 has a system of seven airbags that cover the shoulders 32, the elbows 30, the spine 34 and the knees 36. In one embodiment, an inflation control module 38A may be placed in front of the rider body near the waist.

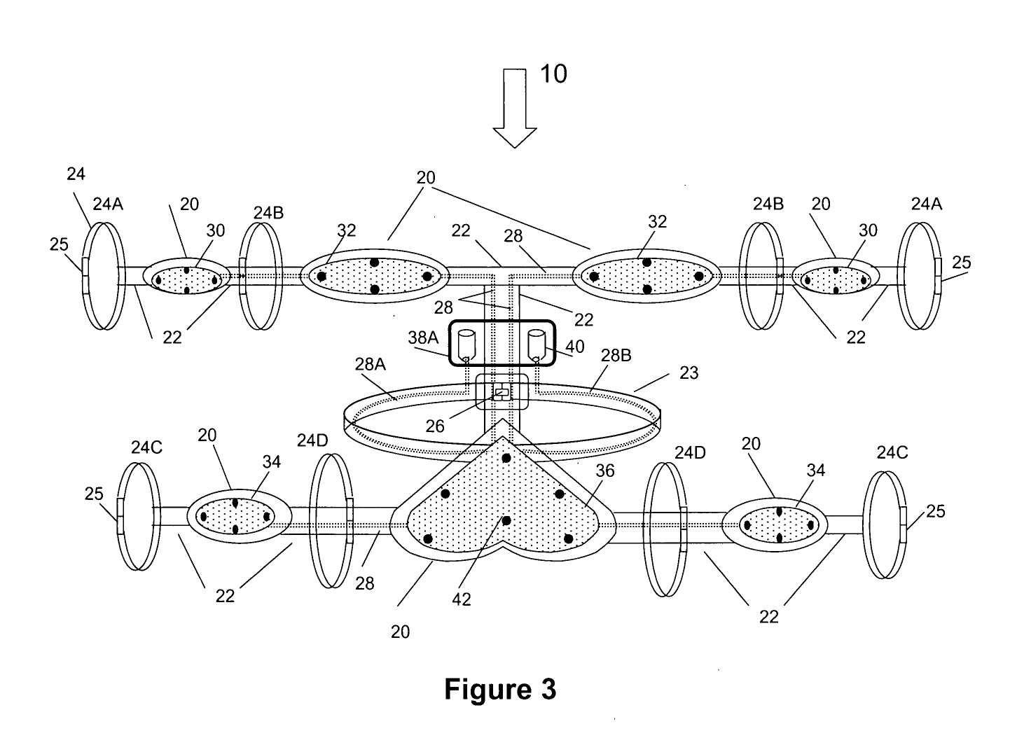

The safety harness 10 is worn and removable using tie means that tie the harness around parts of a motorcycle rider's body 12 using these tie means. A system of tie means with a belt around the waist 23 and other tie means around the limbs as shown later in FIG. 3 keep the safety harness 10 in place on the motorcycle rider's body 12.

The safety harness 10 is worn by a motorcycle rider 12 while riding a motorcycle 14. The safety harness 10 may remain on the rider's body while the rider is engaged in activities away from the motorcycle. These activities may include, taking a break from riding, going to the restroom, walking and sitting for purchasing and consuming food items, and interacting with friends and relatives.

The safety harness 10 may be easily removed from the rider's body by the rider when the rider does not wish to ride on the motorcycle. There may be two harnesses, where each is worn by the rider and the ride companion separately.

The safety harness 10 may be made from straps of a flexible and durable material and is shaped to position and has positioned on it, multiple airbags that correspond to specific human body joints that would bear the impact of a falling motorcycle rider in an accidental separation of the rider from the motorcycle. The specific human body joints include at least, the lower spine and the hip joint, the two shoulders, the two elbows, and the two knees.

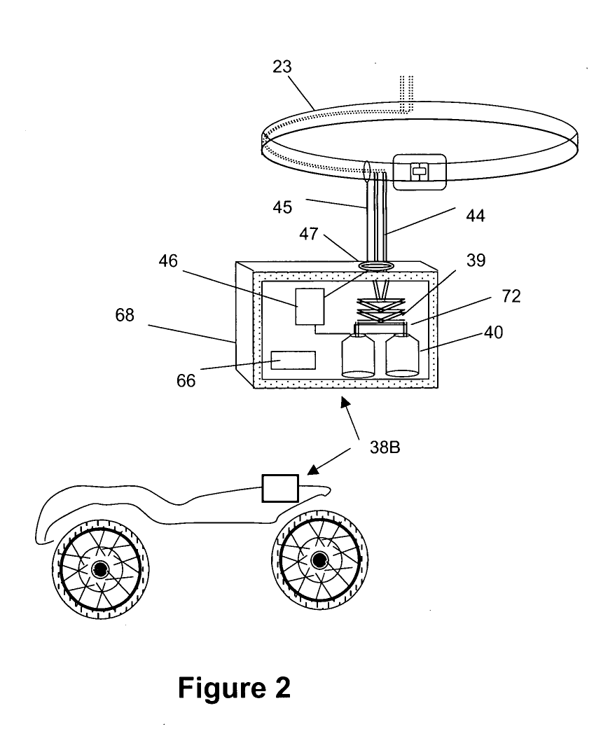

Each of the airbags 30, 32, 34, and 36 on these human body joints is both sized and shaped to the body joint being protected and positioned on the harness to protect the body joint from injury on impact of the motorcycle rider with ground. These multiple airbags are inflated by an inflatable means, where the inflation means 38A may be on the harness itself or the inflation means 38B may be on the motorcycle, as shown in FIG. 2.

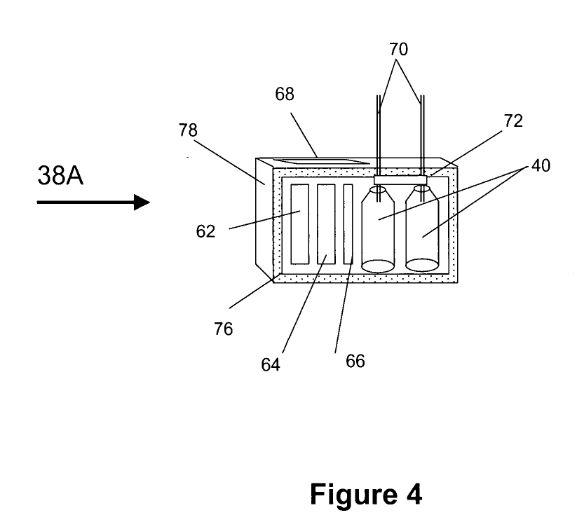

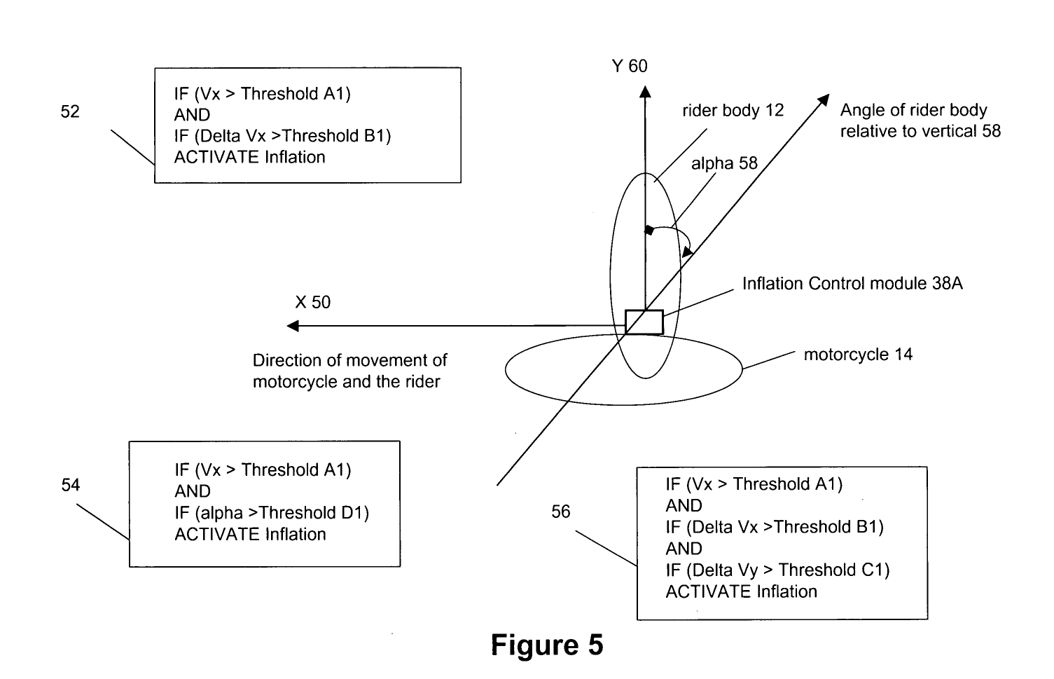

The safety harness 10 is described with reference to FIG. 3. Two different inflation means 38A and 38B are described with reference to FIGS. 2 and 4. FIG. 5 shows the sensor means and related logic means for the inflation control that may be used for the inflation means 38A.

As illustrated in FIG. 3, the harness is preferably made of straps 22 from a flexible and durable material. These materials may include canvass or leather. These straps 22 may be a few inches wide except where the airbags are positioned 20. The harness material including straps may not need to be extra sturdy, as their purpose is limited to holding and keeping the safety harness in position on the motorcycle rider's body.

The safety harness 10 is designed to be easily worn and removable using tie means 24 that tie the harness around parts of a motorcycle ride body using these tie means 24. There may be eight tie means 24, where tie means 24A and 24B tie the safety harness 10 below the elbows and above the elbows and the tie means 24C and 24D tie the safety harness below the knees and above the knees. The tie means 24B above the elbows positioned on the upper arms also keep the shoulder airbags 32 in place. There is also the waist tie means 23 that ties the safety harness around the waist with a buckle 26. The tie means above the knees 24D positioned on the thighs and the tie means 23 around the waist keep the spine and hip joint airbag 34 in place. The tie means 24A-D may include a tie strap 25 that may be a Velcro or clip means that can preferably be operated by one hand.

The safety harness 10 is designed to be light weight and has the weight of only the straps, the collapsed airbags, and the tie means. These may total around a few pounds of weight, without the inflation control means. The safety harness 10 is worn on the outer clothing.

In some embodiments, the weight of the inflation control module 38A including the air storage containers 40 may be another pound or so in weight, for a total of approximately 3 to 4 pounds as the weight of the safety harness 10.

The safety harness 10 on certain parts of the harness is shaped to position 20 and has positioned on it airbags 30, 32, 34 and 36 that correspond to specific human body joints that, it is believed, would bear the impact of a falling motorcycle rider in an accidental separation of the rider from the motorcycle.

As a simplified illustration, if there is an oval shape airbag 32 to protect the shoulder, the harness at that point is also proportionally oval shaped 20 to accommodate the oval shape air bag 32. Likewise for the inverted heart shape air bag 34 for the lower spine and the hip joint, the harness at that point is also proportionally inverted heart shaped 20 to accommodate the inverted heart shape airbag 34.

The airbags 30, 32, 34, and 36 of the safety harness 10 have anchor means 42, which are used to keep the shaped airbags firmly anchored to the oval shape or the inverted heart shape part 20 of the safety harness 22. The anchor means 42 may include a suitable adhesive that may be used at multiple points between the one side of the airbag facing the oval shape harness and the oval shape harness part 20.

The collapsed and folded airbags 30, 32, 34 and 36, on the harness part 20 are protected by a cover material (not shown) which may be made from a transparent plastic. The cover material is selected to easily rupture when the airbags 30, 32, 34, and 36 are inflated.

The expansion size of the airbag is selected to provide a cushion to break the severity of the accidental fall on the rider joints and body. To support this specific purpose, it is believed, the airbags with an expansion of around 2 to 4 inches may be suitable. The actual expansion that may be optimum for this purpose would depend upon the air pressure inside the airbag, the elasticity of the airbag material, and the force of the impact.

The material of these airbags on the safety harness 10 may be different or sturdier than the material of the airbags used in automobiles. In an automobile, airbags protect the occupant body from impact with the interior of the automobile, while the airbag on the safety harness 10 protect the rider body from impact with the road and the ground. Likely impact and sliding action of the airbag against the road surface, in a rider's accidental fall, may rupture the fabric of the airbags that are used in the automobiles. Hence an airbag fabric that would not rupture with friction against a rough surface would be used for the airbags of the safety harness 10.

Further the airbags that are in an automobile have tiny holes to let the air escape after inflation for deflation. Such holes for deflation may not be required for the airbags that would be used in the safety harness 10, as the rider body may also be subjected to secondary impacts after the initial impact with the road and the ground, and the airbag deflation serves no purpose as it does in an automobile airbag. The safety harness after it has been inflated can be easily removed from the rider's body using the tie means 24 as described earlier.

The straps 22 of the safety harness 10 may be hollow or double walled permitting the air channel tubing 28 for the inflation of the airbags to be placed inside these straps. Alternatively the air channels 28 may also be placed on the outside of the straps 22 and protected thereon by similar means of a plastic cover on the channel, as for the airbags.

The specific human body joints, where the multiple airbags may be positioned may include the lower spine and hip joint, the two shoulders, the elbows, and the knees. It is believed these are the body joints that would bear the primary impact of the falling rider from an accidental separation of the rider from the motorcycle. On these joints, each airbag is both sized and shaped to the body joint being protected and positioned on the harness to protect the body joint from injury on impact of the motorcycle rider with ground.

Thus, there may be seven different airbags, two for two shoulders, sized for the shoulders, four for the elbows and knees, sized for these joints, and one for the lower spine and the hip joint. The airbags for all these joints may be oval shaped, except for the spine and hip joint and that may be triangle shaped or an inverted heart shaped to cover the lower spine and the hip joint.

The individual airbags through the safety harness are properly positioned on the rider's body by using tie means 24. As an illustration of these tie means, the shoulder air bags are squarely positioned on the rider's shoulders by the tie means 24B attached to the harness near each of the upper arms. The airbags on the elbows are squarely positioned by the tie means 24B on the harness on the upper arms and tie means 24A below the elbow on the lower arms. The airbag for the spine and the hip joint is squarely positioned by the tie means 23 on the harness around the waist and the tie means 24D on the two thighs. The airbags on the two knees are squarely positioned by the tie means 24D on the thighs and the tie means 24C on the calf below the knees.

The safety harness 10 may be manufactured in different sizes to accommodate different sizes of the people. The harness may be manufactured in sizes of small, medium and large.

Different embodiments of the safety harness 10 are described based on where the inflation control module may be positioned. In a first embodiment, the electronic inflation control module 38A, as illustrated in FIG. 3, is made part of the safety harness itself. This makes the harness self-sufficient, without the need to attach/de-attach or hook/de-hook anything between the harness and the motorcycle.

In a second embodiment, as illustrated in FIG. 2, the multiple airbags are inflated by an inflation means 38B that is affixed to the motorcycle 14. The inflation means part on the motorcycle has an inflation control-module 38B for release of the compressed air. The control module 38B has a housing 68, air bottles 40, air release valve mechanism 72, battery 66, and a release control mechanism 46.

The air bag inflation means on the harness part 23 includes air channel tubing means 44 that run from the control module 38B on the motorcycle to each of the airbags via the harness part 23. Two air channel tubing 44, one for each inflation path on the harness 10 run from the harness part 23 to the module 38B on the motorcycle 14.

In the second embodiment, the safety harness 10 has a trigger mechanism in the inflation control module 38B for air bag inflation that uses pull on a wire means 45 attached to the harness part 23 and the inflation control module 38B on the motorcycle. The airbag activation by the wire pull 45 requires the rider to attach and de-attach the air channel tubing 44 and the pull wire 45 dangling from the harness part 23 with the inflation control module 38B via a collar means 47.

The wire pull means wire 45 that runs from the harness part 23 to the module 38B is attached to the air release mechanism 46 inside the module 38B. The pull wire means 45 is engaged and disengaged between the harness and the module to facilitate mounting and dismounting of the rider from the motorcycle.

The air release mechanism 46 controls the release valves 72. In this embodiment, a part of the length of the air channels 44, may be coiled 39 and would uncoil and extend when pulled. As shown in FIG. 2, the air channel tubing means have extendable coiled tubing means 39 between the control module 38B and the safety harness that uncoil to facilitate continued inflation of the air bags for some time after accidental separation of the rider from the motor motorcycle. The length of the coiled air channel 39 may be approximately one to two feet. These may be coiled on the top of the module 38B in a holding area (not shown) designed for this purpose.

The length of the air channel tubes 44 and the pull wire 45 that would dangle from the harness part 23 may be approximately one foot in length. These lengths, it is believed, would be appropriate that would enable the rider to attach the harness to the inflation control module 38B.

In the second embodiment, the air bag inflation air channel tubing means 44 between the harness and the electronic control module 38B are attachable and detachable via hook collar means 47. A hook mechanism socket means 47 is used to hook the air tubes 44 and the pull wire 45 with the module 38B. For this purpose, the air tubing means 44 and the pull wire means 45 may be integrated as one collar assembly means 47 in the harness to be attached or detached as one assembly 47 with the control module 38B on the motorcycle, facilitating the rider to attach and detach the pull wire 45 and the air tubing 44 from the harness part 23 with the control module 38B with one hand action.

The collar means 47 make it convenient with one hand action to align and attach and detach both the air tubing 44 and the pull wire 45. Such a collar means 47 would facilitate quick removal and engagement of the inflation control 38 with the safety harness 10 and also thus facilitate quick mounting and dismounting of the motorcycle rider from the motorcycle.

For both the first and second embodiment 38A and 38B, the inflation control module has a status panel. The status panel on the module indicates to the rider the active/inactive state of the module. If the module is in the active state, the results of a self test of the control module are displayed. The results may be displayed by use of a color code such as green and red. A switch mechanism is provided to change between the active and inactive states. There may also be a diagnostic mode that may be activated to test the inner workings of the module.

In the first embodiment, the inflation control module 38A is part of the harness and there is nothing on the motorcycle, making the harness self-sufficient. For the first embodiment, the motor motorcycle rider safety harness has a safety harness suitable to be worn by a motorcycle rider. The safety harness is shaped to position and has positioned on it multiple air-bags that correspond to specific locations of a human body joints that would bear the impact of a falling motorcycle rider in an accidental separation of the rider from the motorcycle.

The harness is made of straps from flexible and durable material. The harness is worn and removable using tie means that tie the harness around parts of a motorcycle ride body using the tie means.

The preferred embodiment of the safety harness 10 is described with reference to FIG. 3. The safety harness 10 is made up of straps 22 with specific areas that support specific body joints 20. These specific harness areas are shaped as ovals for the shoulders, the elbows, and the knees. The specific harness area is shaped as a large triangle for the lower spine and the hip joint. The harness may be two or so inches wide for the straps 22 and is hollow to support the placement of air channels 28A and 28B. The areas shaped as ovals may be sized to the specific joint and may be 10 to 12 inches or so long and 4 to 16 inches wide for the shoulder. The oval areas would be smaller for the knee and the elbow joints. The triangle or the inverted heart shape area may be 10-12 inches high and 15 to 18 inches wide at the bottom. The bottom of the triangle shape harness may be partly under the hip joint.

The safety harness 10 has tie means 24A-D for the two lower arms, two upper arms, two for thighs and two for below the knees. These tie means may use Velcro or easily attachable/de-attachable clips 25 that may be used with one hand only.

The harness has airbags 30 for the two elbows, airbags 32 for the two shoulders, airbags 34 for the two knees, and airbag 36 for the lower spine and hips. The airbags are shaped as ovals, 30, 32, and 34 for the joints and as a triangle 36 for the lower spine and the hip joint.

These airbags are attached to the specific harness area by attaching means 42 that attach the airbags on their bottom side of the airbags to the harness. Such attach means which may use a suitable adhesive keep the airbag in position on the harness and thus in position for the specific body joints.

The harness has a harness part 23 that goes and ties around the waist area and ties the harness around the waist with the buckle means 26. This part 23 of the harness is also used to feed the air channels for the air bags on the harness from the inflation control module. The air channels travel around the two sides of the harness 23 and go to the back part 22 of the harness, from where they go up to feed the shoulder and elbow air bags and go down to feed the spine and the knee airbags. These air channels may be made up of the same material as the airbag and are collapsed flat inside the harness. The air channel may as wide as ½ an inch or could be wider or smaller. It is believed that two separate air paths or circuits would help the airbags to be quickly inflated or deployed.

Further, an inflation control module 38A is integrated with the safety harness 10. The control module 38A has (i) sensor means to sense the onset of an accident, (ii) logic means to compute the time for activation of the airbags inflation, and (iii) compressed air storage means 40, for inflating the air-bags at the onset of the accident. The control module 38A is further described later with reference to FIGS. 4 and 5.

The control module 38A is positioned on the harness 10 that when the harness is worn on human body, the control module 38A is in front of the human body near the waist area.

The control module 38A is integrated with the harness through connecting means that connect the gas outlet means in the control module with the air-bags. Thus, harness including the control module is independent of the motorcycle enabling the motorcycle rider to dismount the motorcycle and walk around for activities away from the motorcycle itself.

The connecting means may be used to separate the multiple air bags into at least two different groups where each group would have a separate gas generation means in the control module. This may help in multiple ways. Such as the size of the air bottles may be smaller and thus better positioned inside the control module making the size of control module very compact for this purpose. Also, the air channel path distance between the gas storage means in the control module 38A and the various airbags may be minimized. Also, the control module 38A may have logic that determines which side of the motorcycle the rider would fall and activate the air bags only on one side of the rider's body. Further also, the second airbag system may be used as a secondary system in support of the primary system.

The airbags on the safety harness may be grouped in two or three groupings. The airbags on one side of body, to include a shoulder, an elbow and a knee may be as one group, and the other group may be for the other side of the body. The spine and hip joint air bag may be supported by both gas bottles or a third bottle may be used for this air bag. Having three bottles makes their size smaller to supply these groups of airbags and thus makes for a compact design of the inflation control module.

The first embodiment safety harness inflation control module would have sensor means that would be used to detect the onset of an accidental separation of the rider from the motorcycle. The sensor means may include (i) a velocity sensor, (ii) a de-acceleration sensor, and a (iii) motorcycle/rider angle sensor relative to a vertical axis. Such sensors are quiet common in the prior art.

The module would also have the logic means and input receiving means from these sensors. As one simplified illustration of the logic means, the logic means on an input received velocity value that exceeds a threshold A and an input received de-acceleration value that exceeds a threshold B, would be indicative of an onset of an accidental separation of the rider from the motorcycle. There would be other logic means that use some combination of these three sensor values to determine accidental separation of the rider for different accident modes.

The module has a status panel that indicates the module is in an active/inactive state and if it is in the active state, the results of a self test of the control module are displayed by use of a color code. A switch mechanism is used to change between the states. Such status panels are prior art.

An inflation control module 38A is attached to the harness 23 and has air storage bottles 40 which are attached to tubing means that are positioned inside the harness 23. The control module 38A may be placed in a pouch and attached to the harness part 23. There are two separate tubing means 28A and 28B that are fed from two air cylinders 40 to the two sides of the harness. The module 38A would have a control panel that would indicate the status, as described earlier and also in detail with reference to FIG. 5 for this embodiment.

In general, airbag technology as used in automobiles is prior art. These airbags are adapted for use in the safety harness 10 as described herein. In the airbags that are used in the auto vehicles, the airbags deploy in about 20 milliseconds from the activation time. A similar time would be suitable for the airbags for this safety harness 10 and would allow extra time, as the body would have time to travel until the impact. Thus the current airbag technology that is prior art is eminently suited for application to the safety harness as described herein.

Based on information from the Wikipedia, the airbag sensor is a MEMS accelerometer, which is a small integrated circuit with integrated micro mechanical elements. The microscopic mechanical element moves in response to rapid deceleration, and this motion causes a change in capacitance, which is detected by the electronics on the chip that then sends a signal to fire the airbag. The most common MEMS accelerometer in use is the ADXL-50 by Analog Devices, but there are other MEMS manufacturers as well.

When the frontal airbags are to deploy, a signal is sent to the inflator unit within the airbag control unit. An igniter starts a rapid chemical reaction generating primarily nitrogen gas (N₂) to fill the airbag making it deploy through the module cover. Some airbag technologies use compressed nitrogen or argon gas with a pyrotechnic operated valve (“hybrid gas generator”), while other technologies use various energetic propellants.

As a simplified illustration, if the motorcycle is traveling at a speed of 5 mph and the body is thrown off also at a speed of 5 mph from the motorcycle and then flies 3 feet in the air before hitting the ground, the time from the separation of the body from the motorcycle to the time of the ground impact would be computed as follows. The speed of the motorcycle would be 5×1760×3/60×60=26,400/3600=7.3 ft/sec. The speed of the body would also be 7.3 ft/sec. At this speed, the body to travel 3 feet in the air, would require approximately 400 milliseconds. Similar data may also be calculated for other accident scenarios.

The point of the simplified illustration above is to illustrate that the current airbag technology of automobiles, where the airbags inflate in about 20 millisecond would provide ample time for the inflation of the airbags of the safety harness 10 and provide enough time margin for the many different airbags positioned around the body as well as different accident scenarios that provide for the rider body to travel more than or less than 3 feet before impact.

Based on a simplified illustration, if the oval air bag size, (i) for one shoulder is 10 inches by 6 inches (60 sq. inch), (ii) for one elbow is 8 inches by 4 inches (32 sq. inch), (iii) for one knee is 8 inches by 5 inches (40 sq. inch), and (iv) for the spine as a triangle is 10 inch by 15 inch (100 sq. inch), and if the expansion of each bag is 3 inches, then the total air volume required to inflate one side of the harness plus the spine bag would be (60+32+40+100)×3=approximately 700 cubic inches. Allowing for a margin of 50 cubic inches for air in the tubing, the total air volume would be approximately 750 cubic inches.

An air compression ratio of 1 to 100 would yield an air canister size of close to 8 cubic inches. Such a canister size yields an air bottle size of 3 inches height and a 3 square inches bottom, or a bottle diameter of less than two inches, using π r (square), as the formula for an area of a circle. Such a compression ratio for storing compressed air, it is believed, is reasonable for this purpose. Having two of these air bottles along with the logic circuit card with the sensors, and a electric battery make for a compact inflation control module. Hence such an inflation control module could be a shape that is two inches deep, five inches wide and three and half inches high. Higher air compression ratios, than 1 to 100 would provide even much smaller air bottle sizes.

It is believed such a size control module can be easily positioned as part of the harness near the waist area of the rider's body. Alternatively the module may be positioned on another part of the harness and the body or on the motorcycle itself. Such a size of the control module can be easily positioned on the harness and placed near the waist area. A similar size control module can be easily affixed to the motor cycle near the front of the motorcycle, near the handle bar areas and the fuel tank area, as shown in FIG. 2.

FIG. 4 shows the details of the control module 38A. The module 38A has a housing 78 that houses the sensors 66, the logic 64, the battery 62, the air bottles 40 with air release valves 72, and air channel tubing 70. The housing 78 also has cushion padding 76 that cushions the content. The control module 38A also has a status panel 68. The status panel 68 may be used to show status as well as conduct a test and diagnosis of the functioning and the operational readiness of the inflation control module. Such technology of status panel and test and diagnosis is prior art.

The sensor module 66 may include a velocity/motion sensor, an acceleration sensor, and a rider angle relative to vertical sensor. Such sensor technology is prior art, as being commonly used in many devices including a cell phone such as i-phone from Apple Co. The logic circuit 64 takes these sensor inputs and uses the logic to determine when to activate the release valves 72 to release of air from the two air bottles 40.

The logic may be when the velocity of the motorcycle or the rider body exceeds a threshold A, indicative of a motorcycle with a minimum speed, and when the de-acceleration exceeds a threshold B, indicative of a severe breaking. These conditions may be used to indicate onset of a potential accidental separation of the rider from the motorcycle. In addition, there may be an additional sensor to detect body seat separation from the motorcycle seat, which may be used before the logic activates the air bottles for airbag inflation.

These logic conditions may not be applicable to all modes of accident. In the mode, where the motorcycle slips, there may not be de-acceleration and or the seat separation. In such a mode, the angle of the motorcycle or the rider may be used to trigger release of the compressed air from the bottles. There may be other accident modes, which are not ruled out, whose logic would be programmed in the inflation control module.

It is believed that some combination of four sensors, that of (i) velocity or speed of the motorcycle/rider, (ii) de-acceleration or negative rate of change of the velocity, (iii) motorcycle/rider angle from vertical, and (iv) rider seat separation sensor may be adequate to cover different modes of accidental separation of the rider from the motorcycle. The body seat separation sensor may be a sensor that detects vertical movement of the rider body from the seat that exceeds a threshold. All of these four sensors values may be output from a finely calibrated accelerometer, which detects motion and rate of motion in six different directions.

FIG. 5 shows logic illustrations. The motorcycle 14 movement, the rider body 12 movement, or the control module 38A movement would be same in the X axis direction 50. The rider body 12 or the control module 38A movements in the Y direction 60 would indicate the separation from the motorcycle 14 seat of the rider body 12. The rider angle alpha 58 relative to vertical plane would indicate the angle of the lean of the rider body in cornering of the motorcycle 14 at high speed.

Three different logics 52, 54, and 56 representing onset of an accidental separation of the rider body 12 from the motorcycle 14 are illustrated. Logic 52 would sense an accident based on severity of breaking of the motorcycle based on speed of the motorcycle. Logic 54 would sense an accident based on the rider incline angle alpha based on speed of the motorcycle. Logic 56 would sense an accident based on the speed of the motorcycle, breaking action of the motorcycle and coupled with a body throw off by seat separation represented by an acceleration value in the Y direction 60. A table may be maintained in the logic circuit that would maintain data of the different thresholds A1, B1, C1, and D1 for different speeds of the motorcycle.

The logic circuits that receive inputs, perform a computation and output a control signal to energize a valve are also common in prior art. The air canisters that would store the compressed gas as part of the control module are also common in prior art and so are the release valves.

It is to be appreciated that the safety harness 10 may have different size, placements, and number of the airbags and these are not ruled out. There may be one airbag for the upper body and a plurality for the lower body. The upper body airbag may be one or more airbags that may be made part of a wear jacket on the rider body, where the inflation control module 38A is integrated in a pocket of the wear jacket.

In brief, the motorcycle rider safety harness 10 with multiple airbags positioned on the major joints of the rider body would serve to protect a motorcycle rider body from injury on the major joints from an accidental separation of the rider from the motorcycle. To facilitate the inflation of these airbags at the time of the accident, there are two different inflation means 38A and 38B. The inflation means 38A is on the harness itself, while the inflation means 38B is on the motorcycle.

While the particular method and apparatus as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

What is claimed is:

1. A motor motorcycle rider safety harness comprising:
the safety harness has positioned on it multiple airbags that correspond to specific human body joints that would bear the impact of a falling motorcycle rider in an accidental separation of the rider from the motorcycle.

2. The motor motorcycle rider safety harness as in claim 1, comprising:
the safety harness worn by a motorcycle rider while riding a motorcycle, the harness made of straps from flexible and durable material, the harness is worn and removable using tie means that tie the harness around parts of a motorcycle ride body using the tie means.

3. The safety harness as in claim 1, further comprising:
the specific human body joints including at least, lower spine and hip joint, shoulders, elbows, and knees, where each airbag is both sized and shaped to the body joint being protected and positioned on the harness to protect the body joint from injury on impact of the motorcycle rider with ground.

4. The safety harness as in claim 1, further comprising:
the multiple airbags are inflated by an inflatable means, where the inflation means are on the harness itself.

5. A motor motorcycle rider safety harness comprising:
a. a safety harness worn by a motorcycle rider while riding a motorcycle, the harness made of straps from flexible and durable material, the harness is worn and removable using tie means that tie the harness around parts of a motorcycle ride body using the tie means;
b. the safety harness is shaped to position and has positioned on it multiple airbags that correspond to specific human body joints that would bear the impact of a falling motorcycle rider in an accidental separation of the rider from the motorcycle.

6. The safety harness as in claim 5 further comprising:
the specific human body joints including at least, lower spine and hip joint, shoulders, elbows, and knees, where each airbag is both sized and shaped to the body joint being protected and positioned on the harness to protect the body joint from injury on impact of the motorcycle rider with ground.

7. The safety harness as in claim 5 further comprising:
the multiple airbags are inflated by an inflatable means, where the inflation means is affixed to the motorcycle.

8. The safety harness as in claim 7 further comprising:
the inflation means on the motorcycle having an electronic control-module for controlling release of compressed air, and the air bag inflation means on the harness including tubing means that run from the electronic control module on the motorcycle to each of the air-bags via the harness.

9. The safety harness as in claim 8 further comprising:
a trigger mechanism in the electronic control module for air bag inflation using pull on a wire attached to the rider and the electronic control module on the motorcycle.

10. The safety harness as in claim 9 further comprising:
the pull wire means is engaged and disengaged between the harness and the module to facilitate mounting and dismounting of the rider from the motorcycle.

11. The safety harness as in claim 8, further comprising:
the tubing means have extendable coiled tubing means between the control module and the safety harness, that uncoil to facilitate continued inflation of the air bags for some time after accidental separation of the rider from the motor motorcycle.

12. The safety harness as in claim 8, further comprising:
the air bag inflation tubing means between the harness and the electronic control module are attachable and detachable to facilitate mounting and dismounting of the motorcycle rider from the motorcycle.

13. The motor motorcycle rider safety harness as in claim 8, the control module further comprising:
the module has a status panel that indicates the module is active/inactive state and if in the active state, the results of a self text of the control module, by use of a color code and a switch mechanism to change between the states.

14. A motor motorcycle rider safety harness comprising:
a. a safety harness suitable to be worn by a motorcycle rider;
b. the safety harness is shaped to position and has positioned on it multiple air-bags that correspond to specific locations of a human body joints that would bear the impact of a falling motorcycle rider in an accidental separation of the rider from the motorcycle;
c. a control module integrated with the safety harness, where the control module has (i) sensor means to sense the onset of an accident, (ii) logic means to compute the time for activation of the airbags inflation, and (ii) compressed air storage means, for inflating the air-bags on the onset of the accident.

15. The motor motorcycle rider safety harness as in claim 14 comprising:
the harness made of straps from flexible and durable material, the harness is worn and removable using tie means that tie the harness around parts of a motorcycle ride body using the tie means.

16. The motor motorcycle rider safety harness as in claim 14, the control module further comprising:
the control module is positioned on the harness that when the harness is worn on human body, the control module is in front of the human body near stomach area.

17. The motor motorcycle rider safety harness as in claim 14, further comprising:
the control module is integrated with the harness through connecting means that connect the gas outlet means in the control module with the air-bags, the control module and the harness is independent of the motor motorcycle enabling the motorcycle rider to dismount the motorcycle and walk around for activities away from the motorcycle itself.

18. The motor motorcycle rider safety harness as in claim 15, the control module further comprising:
the connecting means separate the multiple air bags into at least two groups, each group having a separate gas generation means in the control module.

19. The motor motorcycle rider safety harness as in claim 14, the control module further comprising:
the control module has a velocity sensor and an acceleration/de-acceleration sensor, the logic means has receiving means from these sensors, and the logic means, on an input received velocity value exceeds a threshold A and an input received de-acceleration value exceeds a threshold B, and the control module status means is in active state, send a signal to energize a gas generation means in the control module.

20. The motor motorcycle rider safety harness as in claim 14, the control module further comprising:
the module has a status panel that indicates the module is active/inactive state and if in the active state, the results of a self text of the control module, by use of a color code and a switch mechanism to change between the states.
